(19) United States
(12) Patent Application Publication
(10) Pub. No.: US 2012/0197648 A1
(43) Pub. Date: Aug. 2, 2012

(54) AUDIO ANNOTATION

(76) Inventor: David Moloney, Los Gatos, CA (US)

(21) Appl. No.: 13/015,420

(22) Filed: Jan. 27, 2011

(51) Int. Cl. G10L 21/00; H04R 29/00

(52) U.S. Cl. 704/500; 381/56

(57) ABSTRACT

Embodiments provide methods, apparatuses, systems, and articles of manufacture for annotating and receiving inaudible audio annotations associated with audio content. The inaudible audio annotations may be identified by inaudible marker tones. The inaudible audio annotations and the inaudible marker tones may be included in the source file of the audio content.

### BACKGROUND

Computing devices for consuming digital content, such as digital audio content, are becoming more pervasive. Smart phones, computers, digital music players, and other internet ready devices may be utilized to play, broadcast, or stream audio content including music, podcasts, and radio. The audio content may be associated with or audibly reference additional data. For example, an artist of a song may have an associated web page or a podcast may mention a blog located at a particular World Wide Web address.

### BRIEF DESCRIPTION OF THE DRAWINGS

FIG. 1 illustrates a block diagram of an apparatus in accordance with various embodiments;

FIG. 2 illustrates a block diagram of an apparatus in accordance with various embodiments;

FIG. 3 illustrates a block diagram of an apparatus in accordance with various embodiments;

FIGS. 4-5 illustrate example embodiments of modified media content; and

FIGS. 6-8 illustrate flow diagrams in accordance with various embodiments.

### DETAILED DESCRIPTION

While consuming or listening to audio content, data relevant to the audio content may be referenced. For example, while listening to a song, a listener may want additional information related to the artist. As another example, an audio podcast may reference a web page where further information on a particular topic can be obtained. While a listener of the audio content may be able to remember the information and manually access the referenced data at a later time, there is no manner of provisioning the pertinent data to the user based on the audio content.

In the present disclosure, methods, apparatus, systems, and articles of manufacture are disclosed that enable inaudible audio annotations to be encoded into the source files of the audio content. For example, an audio track may contain an inaudible audio annotation which allows an internet ready device to parse and decode the inaudible audio annotation and ultimately retrieve the associated data.

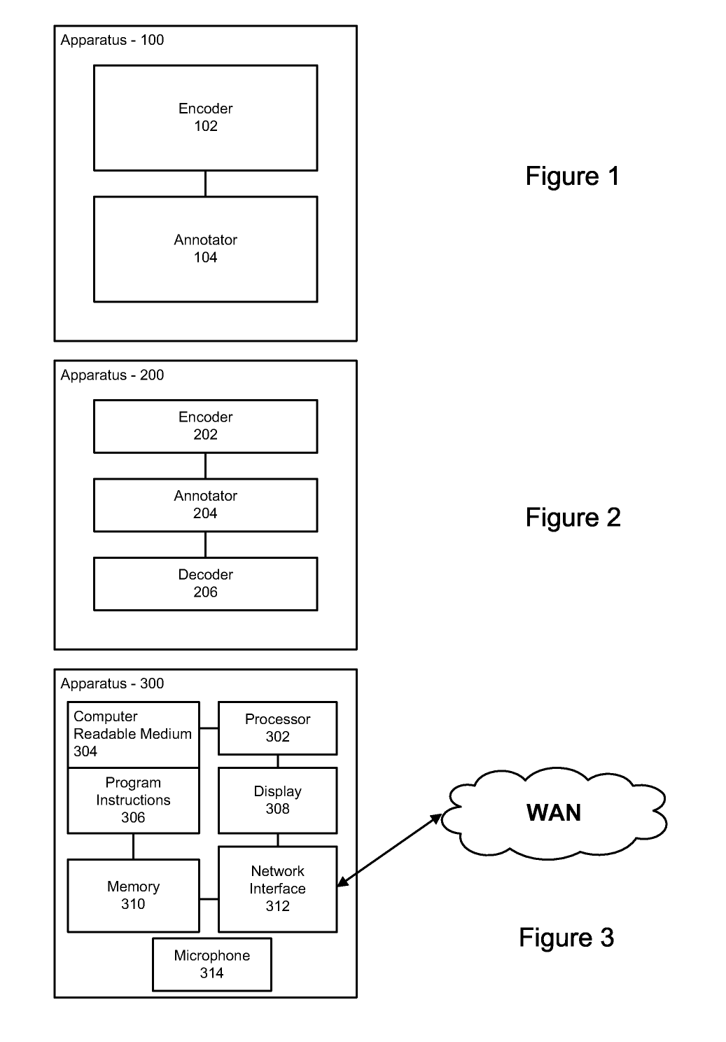

Referring to FIG. 1, an apparatus is illustrated in accordance with various embodiments. The apparatus 100 includes an encoder 102 and annotator 104. Other components may be included without deviating from the scope of the disclosure. In various embodiments, the apparatus 100 may be a computing device, such as but not limited to, a desktop computer, a notebook computer, a netbook, a smart phone, a tablet computer, an internet capable audio player, or any other device configured to consume digital content.

In various embodiments the encoder 102 and the annotator 104 may comprise software, hardware, logic, or any combination thereof. The encoder 102 and the annotator 104 while mentioned in the terms of discrete devices may be incorporated into a single device, for example, an integrated circuit. The encoder 102, in various embodiments, is configured to generate an inaudible audio annotation for audio content, while the annotator 104 is configured to annotate the audio content.

Inaudible audio annotations are audio representations of data that are inaudible to users or listeners, yet detectable by computing devices. For example, an inaudible audio annotation may include a series of tones having a frequency above that of which user or listener is capable of discerning, but is detectable by a computing device. In various embodiments, the inaudible audio annotations may have a frequency above approximately eighteen kilohertz. At or around approximately eighteen kilohertz users generally fail to notice any signals or noise. This frequency can be modified depending on the sensitivity of users, and is therefore, approximate. Other frequencies are contemplated. Inaudible audio annotations are configured to represent data relevant to the audio content. An inaudible audio annotation may include hypertext markup language (HTML) commands, uniform resource locators (URLs), advertisements associated with the audio content, signatures, or other data. Inaudible audio annotations may be configured to convey character strings that enable a computing device to arrive at associated data.

Audio content includes, but is not limited to songs, podcasts, radio broadcasts, and other events. The audio content may utilize various formats including but not limited to Moving Picture Experts Group Layer 1(MPEG-1), MPEG-2, MPEG-3, Advanced Audio Coding (AAC), AAC+, and Ogg Vorbis. Other audio content and other formats are contemplated.

In one embodiment, the inaudible audio annotation may comprise a series of tones having a frequency above which a user may be capable of hearing or distinguishing. The series of tones may represent a series characters, each tone having a distinct frequency associated with a distinct character. When that frequency is received, the character may be determined. In such an embodiment, each tone may be separated from the other tones by, for example, by one kilohertz. The plurality of tones may begin at eighteen kilohertz and progress higher in frequency. Consequently, all the tones may remain inaudible to a user.

In another embodiment, the inaudible audio annotation may comprise a single tone having a frequency above which a user may be capable of hearing or distinguishing. The single tone may be utilized to represent a series of characters. For example, a single tone having a frequency of approximately eighteen kilohertz may be used for a first period of time to represent a first character and a second period of time to represent a second character. The period of time the tone is received may enable a receiver to determine an associated character. The periods of time may vary in increments of seconds, for example. More or less granularity may be used to include more or less characters. With the tone utilizing a frequency above approximately eighteen kilohertz, the inaudible audio annotation may remain unknown to a user or listener.

The encoder 102 is also configured to generate an inaudible marker tone. An inaudible marker tone, in various embodiments, may be a tone or series of tones configured to identify a beginning or end of an inaudible audio annotation. The inaudible marker tone may utilize one or more inaudible tones, for example tones having a frequency above approximately eighteen kilohertz. The inaudible marker tones may signal to a device configured to receive the inaudible audio annotation, that an inaudible audio annotation is available. In contrast, a device not configured to receive an inaudible audio annotation may either ignore the inaudible marker tone, or alternatively output the inaudible marker tone. Due to the frequency of the inaudible marker tone, even when a computing device inadvertently outputs the inaudible marker tone and/or the inaudible audio annotation as sound, their frequency is such that it will remain unknown to a user, and consequently, it will not degrade the overall listening experience.

The encoder 102 may be coupled to the annotator 104. In various embodiments, the annotator 104 may be configured to modify a source file of the audio content with the inaudible marker tone and the inaudible audio annotation. The annotator 104 may insert the inaudible marker tone and the inaudible audio annotation at a time coded point within the audio content, for example at a time code point selected by a user. In various embodiments the annotator 104 may be configured to modify the source file of the audio content either before or after an encoding and compression of the media content. Modifying the source of the audio content may include altering the source file by introducing one or more bits of data, or alternatively, by altering the existing data of the source file. In various embodiments, the annotator 104 may be configured to modify the source file of the audio content with the inaudible audio annotation in a manner that prevents the use of overlapping inaudible audio annotations.

Referring to FIG. 2, a block diagram of an apparatus is illustrated in accordance with another embodiment. The apparatus of FIG. 2 includes an encoder 202, an annotator 204, and a decoder 206. The encoder 202 and the annotator 204 of FIG. 2 may function in a similar manner to the annotator 104 and encoder 102 of FIG. 1. The decoder 206, similar to the encoder 202 and the annotator 204, may include hardware components, software components, logic, or any combination thereof. The decoder 206 may be incorporated into a device along with the encoder 202 and/or the annotator 204.

The decoder 206 may be coupled to the encoder 202 and configured to detect an inaudible marker tone. In one embodiment, the decoder 206 may be configured to monitor the audio content for an inaudible marker tone. The inaudible marker tone may identify a beginning of the inaudible audio annotation. Based upon receipt of the inaudible marker tone, the decoder 206 may process a predetermined number of tones following the inaudible marker tone. Processing a predetermined number of tones may enable the decoder 206 to quickly parse and decode a known amount of data as the inaudible audio annotation.

In another embodiment, the decoder 206 may receive an inaudible marker tone and may continually process tones following the inaudible marker tone until receipt of a second inaudible marker tone. The second inaudible marker tone may identify an end of the inaudible audio annotation. In contrast to the previous embodiment, the use of a second inaudible marker tone may enable audio content to include inaudible audio annotations that vary in length. Varying the length of inaudible audio annotations, for example by shortening URLs, may lower the payload of the inaudible audio annotation.

In one embodiment, the decoder 206 may effectively listen to the audio content. In this embodiment, the decoder 206 may scan the analog signal via a microphone or other device for the inaudible marker tones and the inaudible audio annotation. The decoder 206 may, upon detecting the inaudible marker tones and the inaudible audio annotation, demodulate them back to data for appropriate processing. To reduce errors in the process, for example, errors introduced by harmonics or noise, the inaudible marker tones may include checksums.

Referring to FIG. 3, another block diagram of an apparatus is illustrated in accordance with various embodiments. The apparatus 300 may include a processor 302, a computer readable medium 304 having programming instructions 306 stored thereon, a memory 310, a display 308, a network interface 312, and a microphone 314. Other components may be included without deviating from the scope of the disclosure. In various embodiments, the programming instructions 306 stored on the computer readable medium 304, if executed by a computing device, such as processor 302, may cause the computing device to perform operations, as described herein.

In various embodiments, memory 310 may be a non-volatile memory configured to store and retain data, for example, flash memory. The memory 310 may be configured to store data including audio content. In various embodiments, the memory 310 may be coupled to the display 308, which is configured to display information associated with the audio content and/or data accessed via a network interface 312. The network interface 312 may comprise an interface capable of retrieving data via a wide area network. For example, the network interface 312 may be configured to access the internet via one or more protocols, e.g., TCP/IP, WIFI technology, etc. Alternatively, the network interface 312 may be configured to access a wide area network, such as the internet, via broadband technology.

In one embodiment, the apparatus 300 may be configured to annotate audio content. To annotate the audio content, a user of apparatus 300 may play or consume the audio content stored in memory 310 on the apparatus 300. During consumption or playback of the audio content, a user may temporarily stall or pause the audio content at a time coded point. During the pause, a user may indicate data to be inserted into the audio content as an inaudible audio annotation, for example by typing the data into a user interface (UI).

In one embodiment a user may indicate a URL of a web page to be associated with the audio content. Based on the data, an encoder may generate an inaudible marker tone and an inaudible audio annotation. The inaudible marker tone may comprise an inaudible signal for example a tone with a frequency above approximately eighteen kilohertz. The inaudible marker tone may indicate that a predetermined number of tones or data following the inaudible marker tone constitute the inaudible audio annotation. In this manner, the apparatus may be able to correctly parse the inaudible audio annotation without the need for a second inaudible marker tone.

In another embodiment, based on the data, the encoder may generate a first inaudible marker tone, a second inaudible marker tone, and the inaudible audio annotation. The inaudible audio annotation may be generated in manner similar to that previously described. In this embodiment, the first inaudible marker tone may be configured to identify a beginning of the inaudible audio annotation, while the second inaudible marker tone may be configured to identify an end of the inaudible audio annotation. Therefore, the apparatus 300 may understand any data or tones received between the first inaudible marker tone and the second inaudible marker tone may constitute the inaudible audio annotation.

In various embodiments, after generating the inaudible marker tone or tones and the inaudible audio annotation, the apparatus 300 may be configured to modify the source of the audio content with the inaudible audio annotation. In various embodiments, this may entail modifying various bits within the audio content. Modification may include modifying existing bits, or introducing additional bits. After modification, the audio content may continue playing. The inaudible audio annotation may then be actionable by any player supporting a decoding feature.

In various embodiments, the apparatus 300 may be configured to consume the audio content received from either the memory 310 or a wide area network, via network interface 312. The audio content may include an inaudible audio annotation. The inaudible audio annotation may have been incorporated in the audio content at the time of original production, or alternatively, by a secondary user as previously described.

The apparatus 300 may be configured to perform operations including detecting an inaudible marker tone during playback of audio content, parsing an inaudible audio annotation from the audio content, and decoding the inaudible audio annotation. In various embodiments, detecting the inaudible marker tone may include an audio detection event. For example, the apparatus while streaming data associated with the audio content may run into the inaudible marker tone.

Based on the detection of a first inaudible marker tone, the apparatus 300 may parse the inaudible audio annotation from the audio content. Parsing the inaudible audio annotation may include parsing a predetermined number of tones following detection of an inaudible marker tone, or alternatively, continually parsing tones following the inaudible marker tone until receipt of a second inaudible marker tone. Once the inaudible audio annotation has been parsed, the apparatus may be configured to decode the inaudible audio annotation to retrieve the related data.

In various embodiments, decoding the inaudible audio annotation may result in receipt of a URL, an HTML command, or other data. The processor 302 may then process the data or command to open up a browser or perform other associated operations. In various embodiments, the processor 302 may automatically open a web browser based on receipt of the inaudible audio annotation.

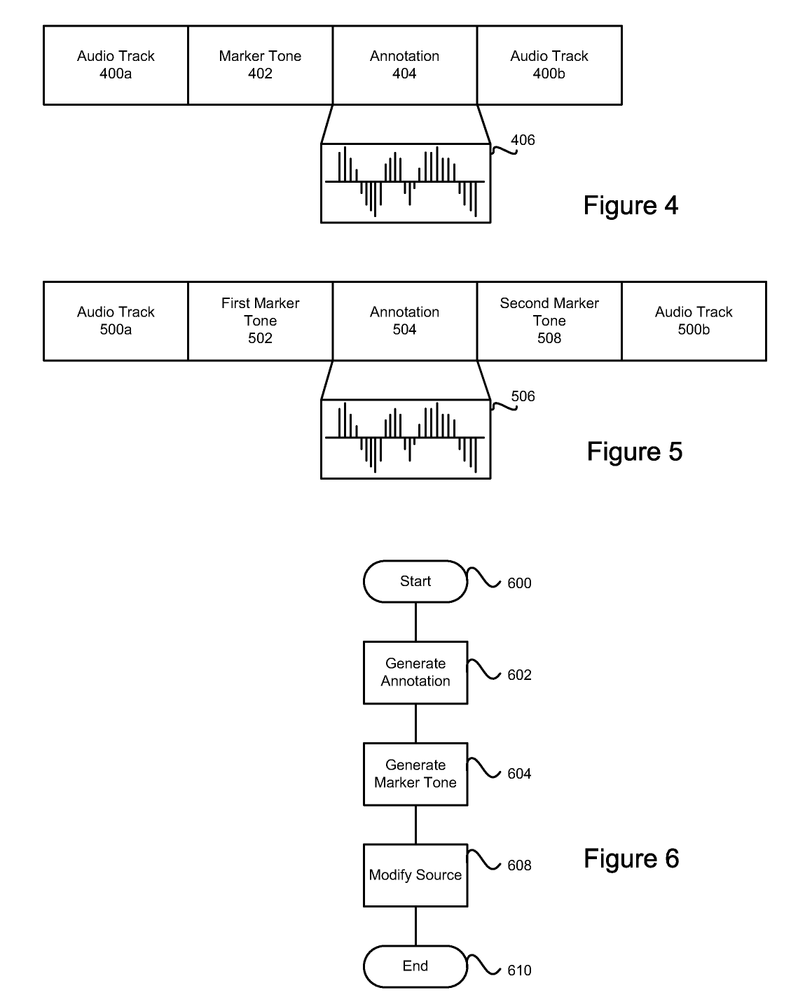

Referring now to FIGS. 4 and 5, a block diagram of audio content incorporating inaudible marker tones and inaudible audio annotations is illustrated. In FIG. 4, a single inaudible marker tone 402 is utilized to identify the data 404. In FIG. 4, the audio content includes a first portion of the audio track 400a and a second portion of the audio track 400b. The two portions are separated by inaudible marker tone 402 and inaudible audio annotation 404.

In FIG. 4, audio track 400a, 400b may be any type of digital consumable audio content. Inaudible marker tone 402 may be a single tone or a series of tones that are inaudible to users. The inaudible marker tone 402 may have a frequency above approximately eighteen kilohertz, other frequencies are contemplated. The inaudible marker tone 402 may identify the beginning of the inaudible audio annotation 404 and may also identify that a predetermined number of tones following the inaudible marker tone comprise the inaudible audio annotation 404. As illustrated the inaudible marker tone 402 may be inserted into the audio track 400a, 400b at a particular time code. The inaudible audio annotation 404 may comprise a stream of plus or minus values that reflect the encoded data.

Referring to FIG. 5, an alternative embodiment is illustrated in accordance with the present disclosure. In FIG. 5, a second inaudible marker tone 508 is utilized to identify an end of the inaudible audio annotation 504. While using two inaudible marker tones, one to identify the beginning of the inaudible audio annotation 504 and one to identify the end of the inaudible audio annotation 504, the inaudible audio annotation 504 may vary in size.

Referring to FIGS. 6-8, flow charts are illustrated in accordance with various embodiments. The operations described in FIGS. 6-8 may be associated with any of the computing devices described with reference to FIGS. 1-3. Referring now to FIG. 6, a method may begin at 600 and proceed to 602, where an encoder may generate an inaudible audio annotation based on data relevant to audio content. In generating the inaudible audio annotation, the encoder may generate a series of inaudible tones. For example, the inaudible tones may utilize frequencies above eighteen kilohertz and represent various characters as the frequencies increase or the length of the tones increase.

After generation of the inaudible audio annotation at 602, the encoder may generate an inaudible marker tone at 604. The inaudible marker tone may be utilized to identify a beginning of the inaudible audio annotation. The inaudible marker tone may include one or more tones having a frequency above, for example, approximately eighteen kilohertz. The inaudible marker tone may be inaudible to a user of the device, but trigger the device to acknowledge the inaudible audio annotation.

After generation of the inaudible marker tone at 604, an annotator of the computing device may modify the source of the audio content with the inaudible marker tone and the inaudible audio annotation. In various embodiments, modifying the source of the audio content may comprise inserting bits associated with the inaudible maker tone and the inaudible audio annotation into the source file of the audio content. Alternatively, modifying the source file may comprise modulating the data within the source file with data of the inaudible audio annotation. Once the source file of the audio content has been modified, a device comprising a decoder may be configured to receive the inaudible audio annotation. The method may end at 610.

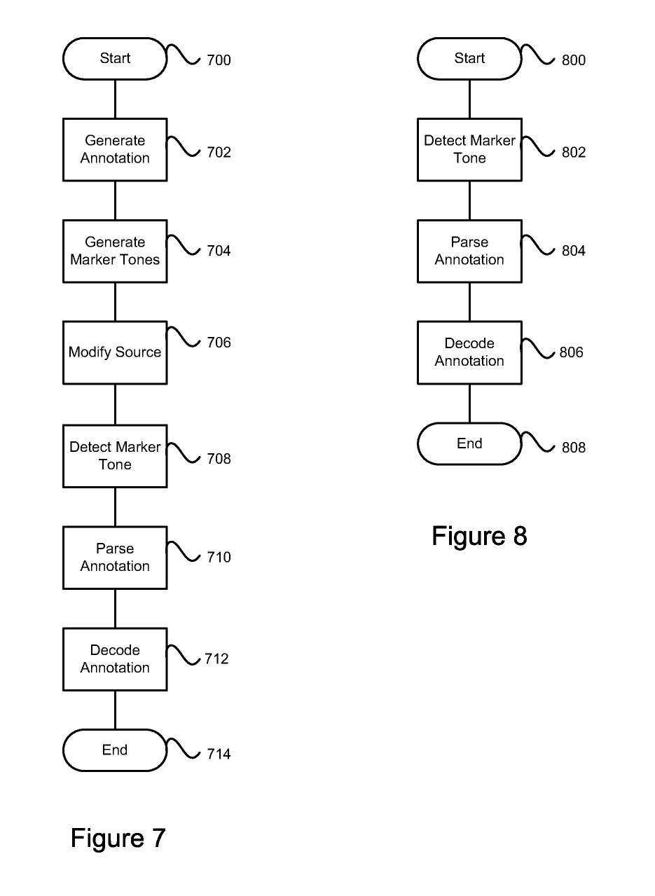

Referring to FIG. 7 a method may begin at 700 and proceed to 702, where an encoder may generate an inaudible audio annotation based on data relevant to audio content. In generating the inaudible audio annotation, the encoder may generate a series of inaudible tones. For example, the inaudible tones may utilize frequencies above, for example, approximately eighteen kilohertz and represent various characters as the frequencies increase, or alternatively, as the length of the tones increase.

After generation of the inaudible audio annotation at 702, the encoder may generate a first inaudible marker tone and a second inaudible marker tone at 704. The inaudible marker tones may be utilized to identify a beginning and an end of the inaudible audio annotation, respectively. The inaudible marker tones may include one or more tones having a frequency above, for example, approximately eighteen kilohertz. The inaudible marker tone may be inaudible to a user of the device, but trigger the device to acknowledge the inaudible audio annotation.

After generation of the inaudible marker tones at 704, an annotator of the apparatus may modify the source of the audio content with the inaudible marker tones and the inaudible audio annotation at 706. In various embodiments, modifying the source of the audio content may comprise inserting bits associated with the inaudible maker tone and the inaudible audio annotation into the source file of the audio content. Alternatively, modifying the source file may comprise modulating the data within the source file with data of the inaudible audio annotation.

With the source of the audio content modified, an apparatus may continue to consume digital audio content. If another inaudible audio annotation is present within the audio content, or if the audio content is re-played, a detector of the apparatus may detect the inaudible marker tone at 708. In various embodiments, detecting the inaudible marker tone may be through a microphone or other listening device detecting a tone above that which is perceptible to humans.

In response to detecting the inaudible marker tone at 708, the apparatus may parse the inaudible audio annotation at 710. Parsing the inaudible audio annotation may include parsing any data discovered between the first inaudible marker tone and the second inaudible marker tone. With the inaudible audio annotation parsed at 710, the apparatus may decode the inaudible audio annotation at 712. Having the inaudible audio annotation decoded, the apparatus may process the data. For example, if the data is a URL the apparatus may present a link to the user to direct them to a related web page. Alternatively, the data may include commands written, for example, in HTML. When the HTML is processed, the apparatus may open a browser and display an associated web page. The method may end at 714.

Referring to FIG. 8, a method associated with detecting and decoding an inaudible audio annotation is illustrated in accordance with various embodiments. The method may begin at 800 with the apparatus consuming audio content at 800. Progressing to 802, the apparatus may detect an inaudible marker tone. The inaudible marker tone may be an inaudible tone configured to indicate the beginning of an inaudible audio annotation. Based on receipt of the inaudible marker tone, the apparatus may parse the inaudible audio annotation at 804.

Parsing the inaudible audio annotation at 804 may include parsing a predetermined number of tones following the inaudible marker tone. The predetermined number of tones may include information relevant to the audio content. With the inaudible audio annotation parsed from the audio content, the apparatus may decode the inaudible audio annotation at 806. Having the inaudible audio annotation decoded, the apparatus may process the data. For example, if the data is a URL the apparatus may present a link to the user to direct them to a related web page. Alternatively, the data may include commands written, for example, in HTML. When the HTML is processed, the apparatus may open a browser and display an associated web page. The method may end at 808.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a wide variety of ways. This application is intended to cover any adaptations or variations of the embodiments discussed herein. Therefore, it is manifestly intended that embodiments be limited only by the claims and the equivalents thereof.

What is claimed is:

1. A method, comprising:
generating an inaudible audio annotation based on data relevant to audio content;
generating an inaudible marker tone, wherein the inaudible marker tone is configured to identify a beginning of the inaudible audio annotation; and
modifying a source file of the audio content with the inaudible marker tone and the inaudible audio annotation to generate a modified source file.

2. The method of claim 1, further comprising:
generating a second inaudible marker tone, wherein the second inaudible marker tone is configured to identify an end of the inaudible audio annotation.

3. The method of claim 1, wherein generating the inaudible audio annotation comprises generating a signal having a frequency above approximately eighteen kilohertz.

4. The method of claim 1, wherein generating the inaudible audio annotation comprises generating an inaudible audio representation of a uniform resource locator (URL).

5. The method of claim 1, wherein modifying the source file of the audio content comprises inserting the inaudible marker tone and the inaudible audio annotation into the source file of the audio content.

6. The method of claim 1, further comprising:
detecting the inaudible marker tone during playback of the modified source file;
parsing the inaudible audio annotation; and
receiving the data relevant to the audio content.

7. The method of claim 6, wherein receiving the data relevant to the audio content comprises receiving a hyper-text markup language (HTML) command to open a web browser and navigate to a web page.

8. The method of claim 1, wherein modifying the source file of the audio content comprises modifying a Moving Picture Experts Group layer-3 (MPEG Level 3) source file.

9. An apparatus, comprising:
an encoder configured to generate an inaudible marker tone and an inaudible audio annotation, wherein the inaudible audio annotation represents data associated with audio content; and
an annotator coupled to the encoder, wherein the annotator is configured to modify a source file the audio content with the inaudible marker tone and the inaudible audio annotation.

10. The apparatus of claim 9, further comprising:
a memory coupled to the encoder and the annotator, wherein the memory is configured to store audio content.

11. The apparatus of claim 9, wherein the audio content is Moving Picture Experts Group layer-3 (MPEG Level 3) content.

12. The apparatus of claim 9, wherein the inaudible audio annotation includes a signal having a frequency above approximately eighteen kilohertz.

13. The apparatus of claim 9, wherein the inaudible audio annotation represents a uniform resource locator (URL).

14. The apparatus of claim 9, wherein the inaudible audio annotation includes a plurality of signals, wherein each of the plurality of signals represents a character and has a frequency above approximately eighteen kilohertz.

15. The apparatus of claim 9, wherein the encoder is further configured to generate a second inaudible marker tone, wherein the second inaudible marker tone is configured to identify an end of the inaudible audio annotation.

16. The apparatus of claim 9, further comprising:
a decoder coupled to the encoder, wherein the decoder is configured to detect the inaudible marker tone, parse the inaudible audio annotation, and decode the inaudible audio annotation to receive the data relevant to the audio content.

17. An article of manufacture including a tangible storage medium having instructions stored thereon that, if executed by a computing device, cause the computing device to perform operations comprising:
detecting an inaudible marker tone during playback of audio content;
parsing an inaudible audio annotation from the audio content, wherein the inaudible audio annotation represents data associated with the audio content; and
decoding the inaudible audio annotation.

18. The article of manufacture of claim 17, wherein the audio content comprises a Moving Picture Experts Group layer-3 (MPEG Level 3) audio track.

19. The article of manufacture of claim 17, wherein the inaudible audio annotation comprises a plurality of signals, wherein each of the plurality of signals represents a character and has a frequency above approximately eighteen kilohertz.

20. The article of manufacture of claim 17, wherein the instructions, if executed by the computing device, cause the computing device to perform operations further comprising:
detecting a second inaudible marker tone, wherein the second inaudible marker tone is configured to identify an end of the inaudible audio annotation.
